(19) United States
(12) Patent Application Publication
(10) Pub. No.: US 2018/0017681 A1
(43) Pub. Date: Jan. 18, 2018

(54) SYSTEM AND METHOD FOR CALCULATING DISTANCE BETWEEN OBJECTS

(71) Applicant: HCL Technologies Limited, Noida (IN)

(72) Inventors: Lalit Kumar Singh, Noida (IN); Pankaj Gupta, Noida (IN)

(21) Appl. No.: 15/650,090

(22) Filed: Jul. 14, 2017

(30) Foreign Application Priority Data
Jul. 18, 2016 (IN) 201611024546

(51) Int. Cl. G01S 19/03; G01C 21/16

(52) U.S. Cl. CPC G01S 19/03; G01C 21/165

(57) ABSTRACT

System and method for calculating distance between objects is disclosed. Location data of a first object is generated. Location data of a second object is obtained. The location data comprise Global Positioning System (GPS) coordinates. The location data of the first object and the second object is compared and a value of distance between the first object and the second object is calculated. The value of distance is converted into a speech output and transmitted in the form of a notification.

### CROSS REFERENCE TO RELATED APPLICATIONS AND PRIORITY

The present application claims priority from Indian Patent Application No. 201611024546 filed on Jul. 18, 2016 the entirety of which is hereby incorporated by reference.

### TECHNICAL FIELD

The present disclosure in general relates to the field of navigation. More particularly, the present disclosure relates to a system and method for calculating distance between objects using Global Positioning System (GPS).

### BACKGROUND

Global Positioning Systems (GPS) are widely used for detecting location of objects, especially in navigational activities. The geographical coordinates of one or more objects may be identified by GPS in order to determine, for example, location of the objects in a traffic scenario. In another example, the location of an object, such as a train or an off road truck may be utilized in industries such as railways and mining.

Typically, in day to day navigation situation(s), distance between two objects may be determined by using GPS coordinates of the two objects. Using GPS coordinates for objects having a line-of-sight between them, may be beneficial in identifying the positioning of the objects with each other. However, in case of situations such as bad weather, steep roads, rails tracks, mining fields, etc. a line-of-sight may not be always available. This may lead to collisions between objects, resulting in accidents and loss of life. Further, industrial operations may have to be stopped in case of these situations, resulting in losses.

### SUMMARY

This summary is provided to introduce aspects related to system and method for an alert or notification system based on predictive analytics, further described below in the detailed description. This summary is not intended to limit the scope of the claimed subject matter.

In one implementation, a system for calculating distance between objects is disclosed. The system includes a positioning unit, a transceiver and a data processing unit coupled to the transceiver and the positioning unit. The positioning unit may be configured to generate location data of a first object. The transceiver may be configured to receive location data from a second object. The data processing unit may be configured to compare location data of the first object with location data of a second object. The location data may at least comprise of Global Positioning System (GPS) coordinates. The data processing unit may further be configured to calculate a value of distance between the first object and the second object based on the comparison. The system may further comprise of a notification generation unit configured to generate a notification based on the calculated value of distance, wherein the notification at least comprises a speech notification generated by converting the computed value of distance into a speech output.

In another implementation, a method for calculating distance between objects is disclosed. The method includes generating location data of a first object. The method further includes receiving location data from a second object. The method further includes comparing location data of the first object with location data of a second object, wherein the location data at least comprises GPS coordinates. Further, the method includes calculating a value of distance between the first object and the second object based on the comparison. The method further includes generating a notification based on the calculated value of distance, wherein the notification at least comprises a speech notification generated by converting the computed value of distance into a speech output.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 depicts a schematic network implementation of a system for calculating distance between objects, in accordance with an embodiment of the present subject matter.

FIG. 2 depicts detailed workings of the system according to an embodiment of the present subject matter.

FIG. 3 depicts a method for calculating distance between objects, in accordance with an embodiment of the present subject matter.

### DETAILED DESCRIPTION

The present systems and methods will now be described more fully hereinafter with reference to the accompanying drawings in which exemplary embodiments of the disclosure are shown. However, the disclosure may be embodied in many different forms and should not be construed as limited to the representative embodiments set forth herein. The exemplary embodiments are provided so that this disclosure will be both thorough and complete, and will fully convey the scope of the disclosure and enable one of ordinary skill in the art to make, use and practice the disclosure. Like reference numbers refer to like elements throughout the various drawings.

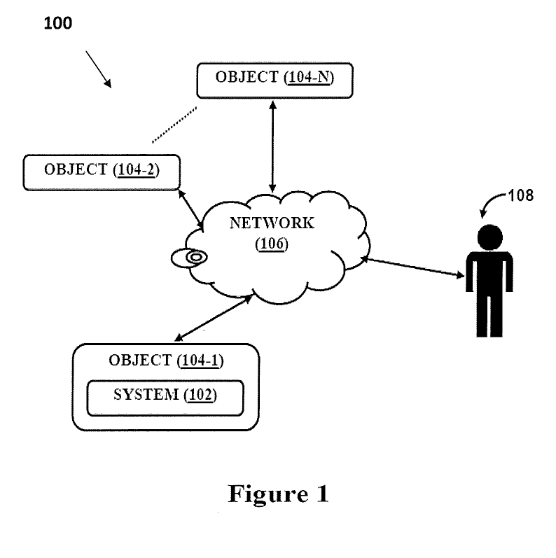

Referring to FIG. 1, disclosed is a network implementation 100 of a system 102 for calculating distance between objects. As illustrated, the system 102 may be part of an object 104-1. In such a scenario, calculation of distance may be done for other objects, depicted by, for example, 104-2 and 104-N, with respect to the object 104-1. For the sake of explanation, objects may be individually referred to as the object 104 and collectively known as the objects 104. In an example, each of the objects 104 may include a system similar to the system 102. In another example, the objects 104 may only comprise a GPS module for transmitting location data to other objects. In the network implementation 100, the objects 104 may be in a vicinity of each other, or may be far off from each other such that no line of sight between the objects 104 is available.

As depicted, the system 102, installed within the object 104-1, communicates with the other objects 104, via a network 106. In general, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like. In specific examples, the network 106 may be one of RF network, Wi-Fi network, Wi-MAX network, GSM network, GPRS network, LTE network, or LORA network.

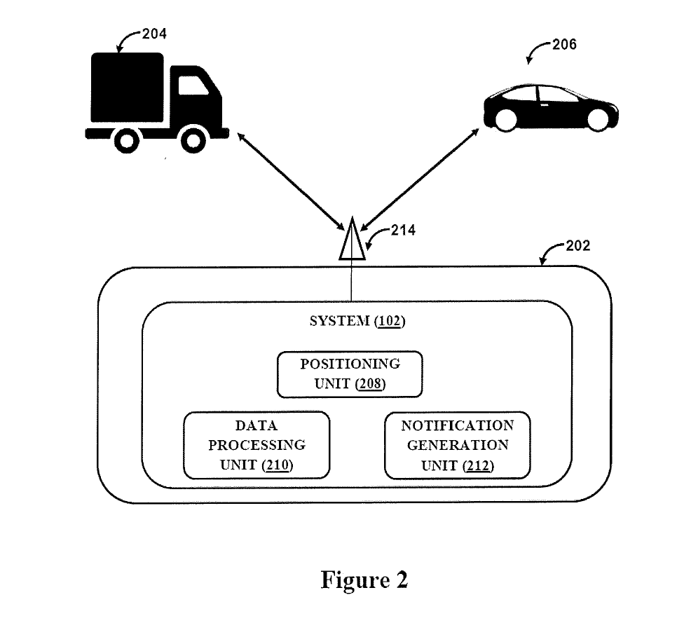

In an embodiment, the system 102 may generate a notification when distance from a particular object is less than or equal to a predefined threshold. In the embodiment, the system 102 may calculate the distance between the object 104-1 and other objects, compare the distance with the predefined threshold and generate the notification when the distance is less than equal to the predefined threshold. In an implementation, the predefined threshold may be different for different objects. Further, the notification may be transmitted to a user 108. In an example, in case the object 104 is a vehicle driven by the user 108, the notification may be presented to the user using a display device of the vehicle. In another example, the notification may also be provided to the user 108, remotely. For example, the notification may be provided to the user 108 on a mobile device (not shown) associated with the user 108. The notification, in one implementation, may be a display notification, a speech notification, a tactile notification, and the like. The calculation of distance between the objects and the generation of notifications is described in detail with respect to FIG. 2.

FIG. 2 illustrates the system 102 in detail, in accordance with an embodiment of the present disclosure. In an embodiment, the system 102 may be installed in a vehicle 202 such that the vehicle 202 may communicate with other vehicles (or objects) using the system 102. For the sake of clarity, only two other vehicles, i.e., a truck 204 and a car 206, are displayed in the figure. However, a person skilled in the art would appreciate that the system 102 may communicate with more vehicles within a vicinity or far-off from the vehicle 202. Further, the truck 204 and the car 206 may have systems similar to the system 102 installed therein.

As depicted, the system 102 may include a positioning unit 208, data processing unit 210 and notification generation unit 212. The system 102 may also include a transceiver 214 for communicating with other vehicles. In operation, the transceiver 214 may receive location data from one or more other vehicles, i.e. the truck 204 and the car 206. In an implementation, the location data received from the other vehicles 204, 206 may include GPS coordinates for the other vehicles 204, 206. The GPS coordinates, in one example, may comprise of longitude and latitude information for the other vehicles 204, 206.

Based on the received location data, the data processing unit 210 may calculate distance between the vehicle 202 and other vehicles 204, 206 respectively. The data processing unit 210 may calculate the distance based on location data of the vehicle 202. The location data of the vehicle 202, in one example, may be obtained by the positioning unit 208. The positioning unit 208 may include a GPS module (not shown) that may determine location of the vehicle 202 in real-time.

The data processing unit 210 may receive the location data of the vehicle 202 from the positioning unit 210. Further, the data processing unit may receive the location data of the other vehicles 204, 206 from the transceiver 214. Based on comparison of the location data of the vehicle 202 to the location, the data processing unit 210 may calculate the distance between the vehicle 202 and each of the other vehicles 204, 206. The calculated distance between the vehicles may be transmitted by the data processing unit 210 to the notification generation unit 212.

The notification generation unit 212, in one embodiment, may compare the calculated distance from each of the other vehicles 204, 206 to a predefined threshold. In an implementation, the predefined threshold may vary for different objects. For example, a predefined threshold for distance between a car and a truck may be greater than a distance between two cars. Similarly, the predefined threshold for distance between two vehicles may be greater than the distance between a vehicle and a stationary object, such as a fence. Also, the predefined threshold may be customized based on specific requirements. The notification generation unit 212, in one embodiment, may generate a notification when the distance between the vehicle 202 and one of the other vehicles 204, 206 is less than or equal to the predefined threshold.

In an embodiment, the notification may be generated in the form of a speech notification. That is, the notification generation unit 212 may covert a numeric value of the distance between the vehicle 202 and one of the other vehicles 204, 206, and covert the numeric value into a speech output. The speech output may then be transmitted to a user in the form of the speech notification. In an example, in case the vehicle 202 is a car or a minivan, the speech notification may be transmitted through a sound-system of the car. In another example, in case the vehicle is a motor-bike, the speech notification may be transmitted to a speaker attached to a helmet of a rider, riding the motor-bike. Such a speech notification may help drivers and riders in a manner that they are aware of other vehicles/objects in their path, even without having a line-of-sight. The embodiments of the present disclosure may be particularly advantageous in situations of minimum or no visibility, such as bad weather, hilly terrains, steep curves, tracks, and the like.

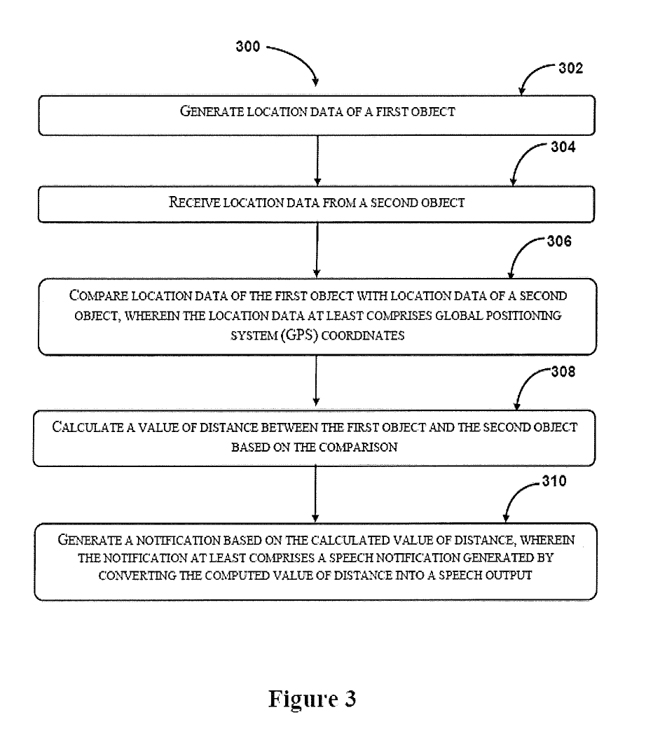

Referring now to FIG. 3, a method 300 for calculating distance between objects is illustrated. The method may start at step 302, wherein location data of a first object may be generated. In an example, the first object may be a vehicle. Further, the location data may include data about geographical coordinates for the first object.

At step 304, location data of a second object may be obtained. In an implementation, the location data may be obtained over a network. The network may be one of a RF network, Wi-Fi network, Wi-MAX network, GSM network, GPRS network, LTE network, or LORA network.

At step 306, location data of the first object may be compared with the location data of the second object. As described, the location data may include Global Positioning System (GPS) coordinates.

At step 308, a value of distance between the first object and the second object may be calculated. In an implementation, the value of distance may be calculated by comparing the GPS coordinates of the first object with the GPS coordinates of the second object, extracted from the respective location data.

At step 310, a notification based on the calculated value of distance may be generated. In an implementation, the notification may be generated in the form of a speech notification. The speech notification, in one example, may be generated by converting the value of distance between the first and second objects into a speech output. In an implementation, the notification may be generated when the value of distance between the first object and the second object is less than or equal to a predefined threshold.

Although implementations for methods and systems for enabling a maintenance activity of an equipment have been described in language specific to structural features and/or methods, it is to be understood that the appended claims are not necessarily limited to the specific features or methods described. Rather, the specific features and methods are disclosed as examples of implementations for generating real time network alerts based on analytics.

We claim:

1. A system for calculating distance between objects, the system comprising:
a positioning unit for generating location data of a first object;
a transceiver for receiving location data from a second object;
a data processing unit coupled to the transceiver and the positioning unit, the data processing unit configured to:
compare location data of the first object with location data of a second object, wherein the location data at least comprises Global Positioning System (GPS) coordinates;
calculate a value of distance between the first object and the second object based on the comparison; and
a notification generation unit configured to:
generate a notification based on the calculated value of distance, wherein the notification at least comprises a speech notification generated by converting the computed value of distance into a speech output.

2. The system of claim 1, wherein the notification further comprises a text notification, a tactile notification or a visual indicator.

3. The system of claim 1, wherein the notification is generated when the value of distance between the first object and the second object is less than or equal to a predefined threshold value.

4. The system of claim 1, wherein the transceiver receives the location data of the second object over a wireless network.

5. A method for calculating distance between objects, the method comprising:
generating location data of a first object;
receiving location data from a second object;
comparing location data of the first object with location data of a second object, wherein the location data at least comprises Global Positioning System (GPS) coordinates;
calculating a value of distance between the first object and the second object based on the comparison; and
generating a notification based on the calculated value of distance, wherein the notification at least comprises a speech notification generated by converting the computed value of distance into a speech output.

6. The method of claim 1, wherein the notification further comprises a text notification, a tactile notification or a visual indicator.

7. The method of claim 1, further comprising generating the notification when the value of distance between the first object and the second object is less than or equal to a predefined threshold value.

8. The method of claim 1, further comprising receiving the location data of the second object over a wireless network.
